(19) United States
(12) Patent Application Publication
(10) Pub. No.: US 2025/0133258 A1
(43) Pub. Date: Apr. 24, 2025

(54) DEVICE, METHOD AND PROGRAM FOR COMBINING VIDEO SIGNALS

(71) Applicant: NIPPON TELEGRAPH AND TELEPHONE CORPORATION, Tokyo (JP)

(72) Inventors: Toshihito FUJIWARA, Musashino-shi, Tokyo (JP); Tatsuya FUKUI, Musashino-shi, Tokyo (JP); Ryota SHIINA, Musashino-shi, Tokyo (JP); Hiroya ONO, Musashino-shi, Tokyo (JP)

(73) Assignee: NIPPON TELEGRAPH AND TELEPHONE CORPORATION, Tokyo (JP)

(21) Appl. No.: 18/681,484

(22) PCT Filed: Aug. 11, 2021
(86) PCT No.: PCT/JP2021/029617

§ 371 Date: Feb. 5, 2024

(51) Int. Cl. H04N 21/431

(52) U.S. Cl. CPC H04N 21/4312

(57) ABSTRACT

An object of the present disclosure is to reduce a time delay from inputting an asynchronous video to outputting the synthesized video.

The present disclosure relates to a device for synthesizing a plurality of video signals input asynchronously into a video signal displayed on one screen, in which, when input of an input frame is not completed for any one of the plurality of video signals, using data of a past input frame of the video signal instead of data whose input has not been completed, the video signal displayed on the one screen is synthesized.

### TECHNICAL FIELD

The present disclosure relates to a video synthesizing system that synthesizes screens into one screen from a plurality of video input signals and outputs the screen.

### BACKGROUND ART

In recent years, many video devices have been used. Various numbers of pixels (resolution), frame rates, and the like are used for videos of such many video devices. Although video signals of these video devices differ in physical signals, control signals, and the like, depending on the standard, the video signal of one screen is transmitted using 1/frame rate seconds. For example, in the case of a video signal of 60 frames per second, the video of one screen is transmitted in 1/60 seconds, that is, approximately 16.7 milliseconds (hereinafter referred to as 60 fps (frame per second)).

As a method of using these videos, there is a form in which a plurality of cameras are displayed on monitors that are smaller in number than the number of cameras, such as in a video conference. In such a case, screen synthesis is performed, for example, such as dividing and displaying a plurality of videos on one screen, or embedding other video screens in a reduced size display in a certain video screen.

Normally, the timings of video signals are not synchronized, and the timings of other video signals to be synthesized are different. Therefore, the signals are temporarily buffered in a memory or the like and then synthesized. As a result, a delay occurs in the output of the synthesized screen.

When it is assumed that an ensemble performance or the like at a remote place or the like is performed in a video conference in which such screen synthesis is performed, the delay related to the synthesis greatly impairs its realization. For example, in the case of a song with 120 beats per second (hereinafter referred to as 120 BPM (beat per minute)), the time of one beat is 60/120 seconds=500 milliseconds. Assuming that it is necessary to match this with an accuracy of 5%, it is necessary to suppress the delay from capturing by the camera to display to within 500×0.05=25 milliseconds.

In actuality, from capturing by the camera to display, in addition to processing related to synthesis, it is necessary to include other delays such as image processing time in the camera, display time on the monitor, and time related to transmission. As a result, in the related art, it is difficult to perform cooperative work in applications where timing is important, such as ensemble performances while viewing videos mutually at remote places.

Therefore, for cooperative work in which a low delay request is severe, it is necessary to provide a system for synthesizing a plurality of screens from a plurality of bases or the like, and for reducing a time delay from inputting an asynchronous video to outputting the synthesized video.

### CITATION LIST

### Non Patent Literature

[NPL 1] VESA and Industry Standards and Guidelines for Computer Display Monitor Timing (DMT), Version 1.0, Rev. 13, Feb. 8, 2013

### SUMMARY OF INVENTION

### Technical Problem

An object of the present disclosure is to reduce a time delay from inputting an asynchronous video to outputting the synthesized video.

### Solution to Problem

In order to achieve the above object, according to the present disclosure, a plurality of asynchronous videos are input, and in output synthesis, without waiting for the completion of input for one screen, shortage of input data is supplemented with past frame data, and the screen is synthesized and output with the input data as soon as possible at a rate higher than the input frame rate.

Specifically, a device and method according to the present disclosure relate to
a device and method for synthesizing a plurality of video signals input asynchronously into a video signal displayed on one screen,
in which, when input of an input frame is not completed for any one of the plurality of video signals,
using data of a past input frame of the video signal instead of data whose input has not been completed,
the video signal displayed on the one screen is synthesized.

Specifically, a program according to the present disclosure is a program for causing a computer to realize functions of the device according to the present disclosure, and is a program for causing a computer to execute steps of the method executed by the device according to the present disclosure.

### Advantageous Effects of Invention

The present disclosure can reduce a time delay from inputting an asynchronous video to outputting the synthesized video.

### BRIEF DESCRIPTION OF DRAWINGS

FIG. 1 illustrates an example of information of a screen included in a video signal.

FIG. 2 illustrates an example of a system configuration of the present disclosure.

FIG. 3 illustrates an example of combining four input frames into one output frame.

FIG. 4 illustrates an example of timing when four input frames are combined into output frames.

FIG. 5 illustrates an example of output video signals output at time t5.

FIG. 6 illustrates an example of timing when four input frames are combined into output frames.

FIG. 7 illustrates an example of output video signals output at time t5.

FIG. 8 illustrates a configuration example of a video synthesizing device.

### DESCRIPTION OF EMBODIMENTS

Embodiments of the present disclosure will be described hereinafter in detail with reference to the drawings. It is to be understood that the present disclosure is not limited to the embodiments described below. The embodiments are merely exemplary and the present disclosure can be implemented in various modified and improved modes based on knowledge of those skilled in the art. Constituent elements with the same reference numerals in the present specification and the drawings represent the same constituent elements.

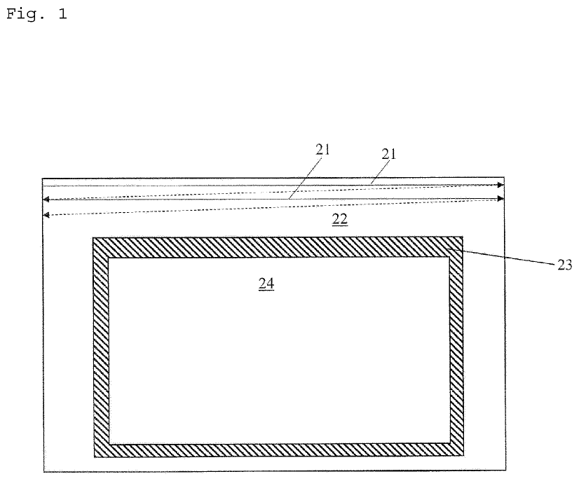

FIG. 1 illustrates an example of information of a screen included in a video signal. Information of the screen is transmitted by scanning the screen in the lateral direction for each scanning line 21 and sequentially scanning the scanning lines 21 below. This scanning includes overhead information/signals such as a blanking portion 22 and a border portion 23 in addition to a display screen 24. The blanking portion 22 may include information other than video information such as control information and audio information.

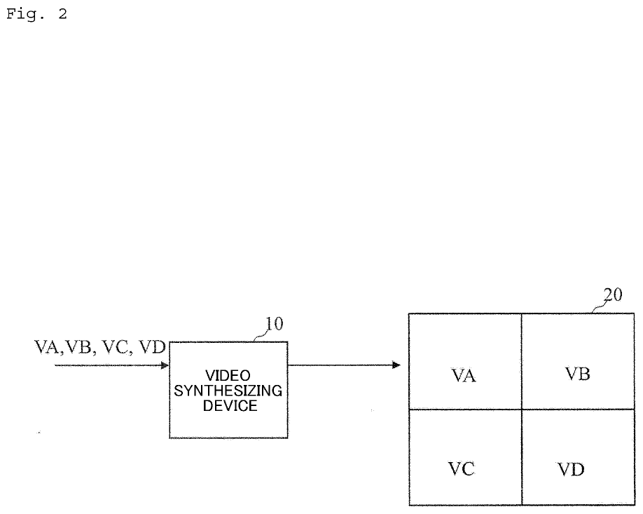

FIG. 2 illustrates an example of a system configuration of the present disclosure.

In the present disclosure, as an example, four video signals V1 to V4 are input to a video synthesizing device 10, and the video synthesizing device 10 synthesizes the video signals into a video signal displayed on one screen 20 and outputs the synthesized video signals. The video synthesizing device 10 outputs a video signal VA from input 1 and a video signal VB from input 2 to the upper part of the screen 20, and a video signal VC from input 3 and a video signal VD from input 4 to the lower part of the screen 20.

The video signal of one screen is transmitted using 1/frame rate seconds. For example, in the case of a video signal of 60 frames per second, the video signal of one screen is transmitted in 1/60 seconds, that is, approximately 16.7 milliseconds (hereinafter referred to as 60 fps (frame per second)). The information of one screen at each point of time included in the video signal is referred to as a “frame,” the information of one screen of each video signal input to the video synthesizing device 10 is referred to as an “input frame,” and the information of one synthesized screen output from the video synthesizing device 10 is referred to as an “output frame.”

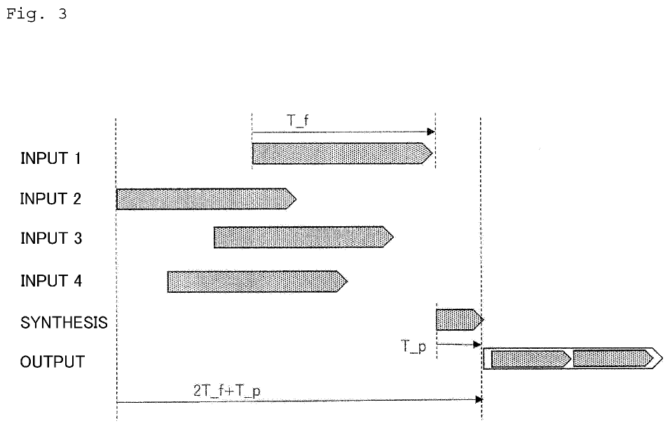

FIG. 3 illustrates an example in which four videos at different timings are input, synthesized into a video signal displayed on one screen, and output. A case in which the video synthesizing device 10 reads all input video screens, synthesizes them, and outputs them is considered. In this case, assuming that the frame time is T_f and the synthesis processing time is T_p, the output frame is delayed by 2T_f+T_p at the maximum from the input point of time of the first input frame. For example, considering a 60 fps video, there is a likelihood that the synthesized video will include a delay of 2 frame times or more, that is, 33.3 milliseconds or more.

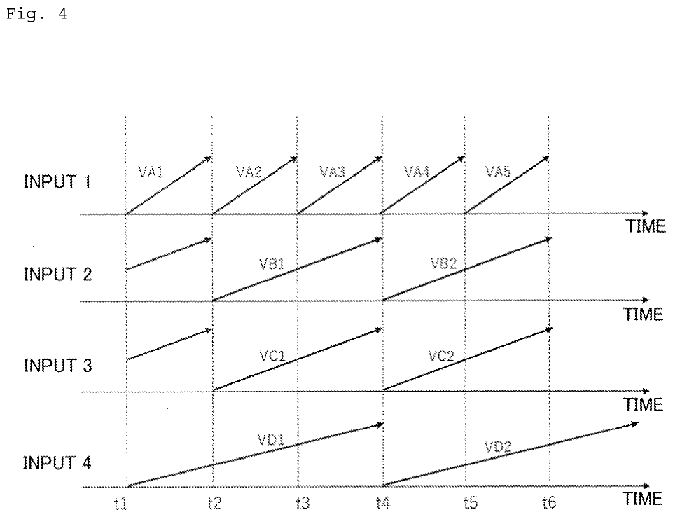

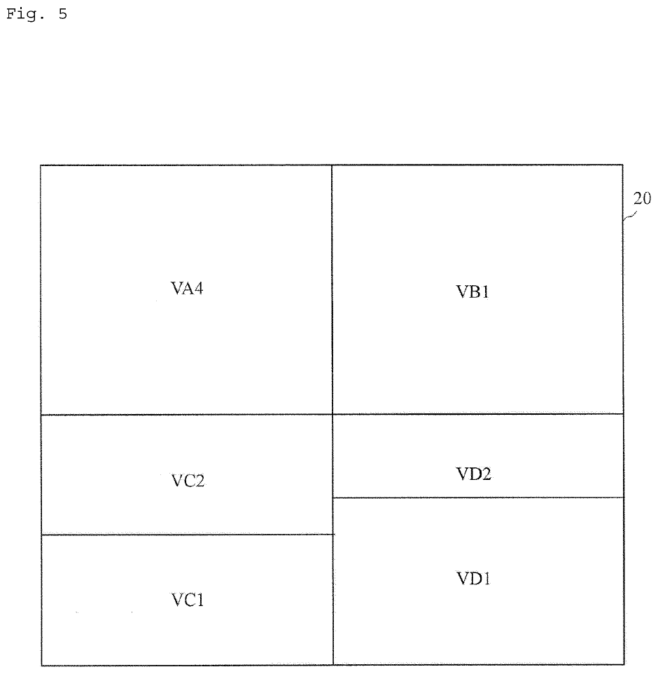

The present disclosure relates to a system for inputting a plurality of asynchronous videos and synthesizing the images, and in output, a screen is synthesized and output at a rate higher than an input frame rate. At this time, in the present disclosure, shortage of input data is supplemented with data of past input frames that have already been input. Hereinafter, an example in which four input screens are reduced to ¼ and combined into a screen divided into four as illustrated in FIG. 2 will be specifically described with reference to FIGS. 4 and 5.

FIG. 4 illustrates an example of the timing when input frames input from input 1 to input 4 are combined into output frames. The horizontal axis indicates the passage of time, the vertical axis indicates the degree of completion of data for one frame in the upward direction from the start of input of data of an input frame with the horizontal axis for each input as a starting point, and the end point on the arrow side indicates the completion of data input. The video synthesizing device 10 synthesizes input frames of an arbitrary frame rate and outputs output frames at times t1 to t5.

For example, input frames of video signals VA1 to VA4 are input from input 1 at times t1 to t5, input frames of video signals VB1 and VB2 are input from input 2 at times t2 and t4, input frames of video signals VC1 and VC2 are input from input 3 at times t2 and t4, and input frames of video signals VD1 and VD2 are input from input 4 at times t1 and t4. For inputs 2 and 3, an output frame is output at a frame rate which is twice the input frame, and for input 4, an output frame is output at a frame rate which is three times the input frame.

FIG. 5 illustrates an example of a video signal synthesized into an output frame which starts to be output at time t5. At this time, the data of the input frames input to the video synthesizing device 10 by t5 can be output. For the video signal VC input from input 3, only a half of the video signal VC2 is input at time t5. In this case, usable input data in the video signal VC2 is used for the output frame, and the previous video signal VC1 is used instead of the unusable data in the video signal VC2.

For the video signal VD input from input 4, only ⅓ of the video signal VD2 is input at time t5. In this case, usable input data in the video signal VD2 is used for the output frame, and the previous video signal VD1 is used instead of the unusable data in the video signal VD2.

For the video signal VB input from input 2, only a half of the video signal VC2 is input at time t5. In this case, only the previous video signal VB1 is used without using the video signal VB2.

In the present disclosure, not only the input completion data at the start of output of the output frame is used as a reference, but also the data which has been input-completed before individual data output of the output frame can be used as a reference for synthesis.

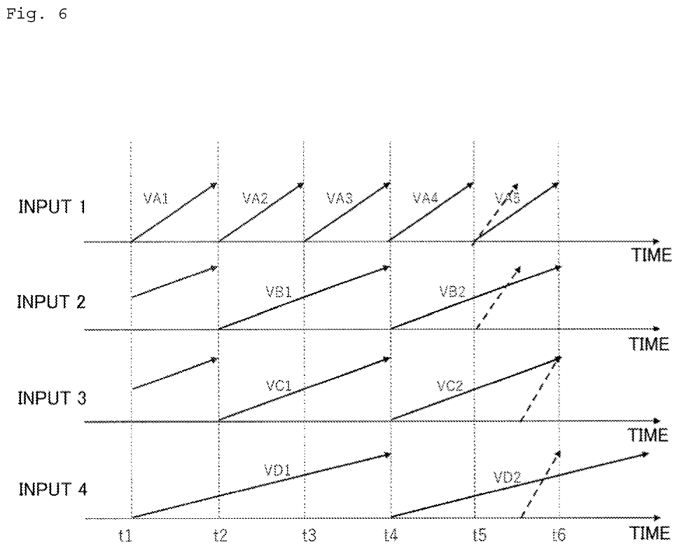

FIG. 6 illustrates the timing of an output frame which starts to be output at time t5 and is output-completed at time t6, added by a broken line, in the case of synthesizing data which has been input-completed before individual data output of the output frame in FIG. 4 as a reference. Since the data corresponding to input 1 and input 2 are at the upper part of the screen, the data are output from t5 to the middle time between t5 and t6, and since the data corresponding to input 3 and input 4 are at the upper part of the screen, the data are output from the middle time between t5 and t6 to t6.

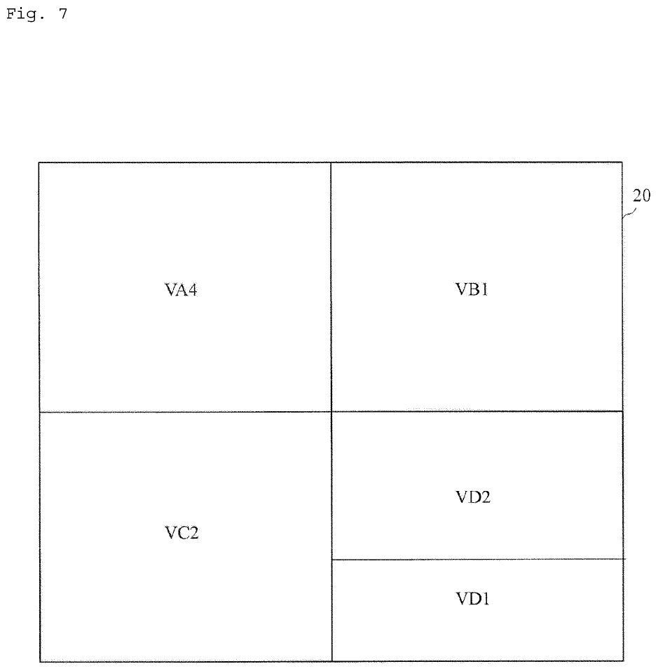

FIG. 7 illustrates an example of a video signal which starts to be output at time t5 and is synthesized into an output completion output frame at time t6. At this time, the data of the input frames input to the video synthesizing device 10 by the time of output can be output. For the video signal VC input from input 3, since only half of the video signal VC2 is input at time t5 but the input is completed before the output is completed, in this case, only the data of the video signal VC2 is used for the output frame.

For the video signal VD input from input 4, only ⅓ of the video signal VD2 is input at time t5, but the input is completed until ⅗ of the video signal VD2 in which the output frame of the broken line overtakes the input. In this case, the previous ⅗ of usable input data in the video signal VD2 is used for the output frame, and thereafter, the previous video signal VD1 is used instead of the unusable data in the video signal VD2.

For the video signal VB input from input 2, only a half of the video signal VC2 is input at time t5. In this case, only the previous video signal VB1 is used without using the video signal VB2.

The difference in output from input 2 to input 4 depends on the difference in setting. For example, when a flag indicating that partial use of the frame data is prohibited is attached to the video signal VB, the video signal VC2 is not used in the output frame output at time t5 like the video signal VB.

In the present disclosure, it is not necessary that all the outputs have a rate higher than the input frame rate, and there may be a video signal having the same frame rate of the input frame and the output frame, such as the video signal VA from input 1.

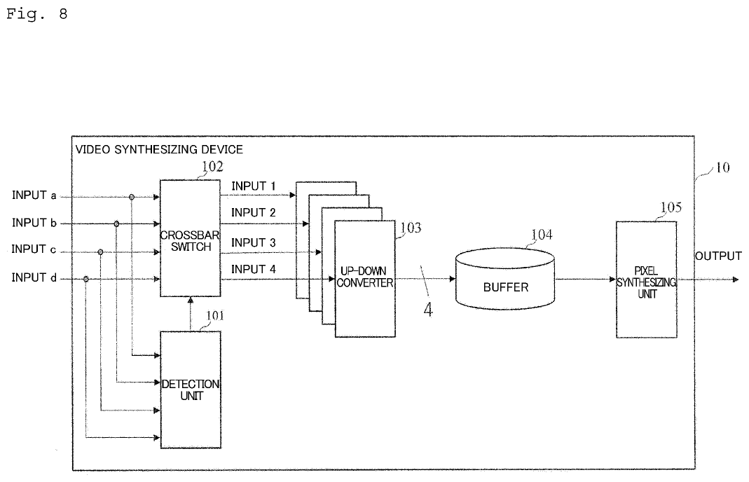

FIG. 8 illustrates a configuration example of the video synthesizing device 10 according to the present embodiment. The video synthesizing device 10 according to the present embodiment includes a detection unit 101, a crossbar switch 102, an up-down converter 103, a buffer 104, and a pixel synthesizing unit 105. Although FIG. 8 illustrates four inputs and one output, an arbitrary number of inputs and outputs may be used.

Reference numeral 101 denotes a functional unit for detecting the input order within the frame time for N inputs. Reference numeral 102 denotes a crossbar switch, which has a function of rearranging and outputting the input order from reference numeral 101 in the order of detection results. Reference numeral 103 denotes an up-down converter for enlarging and reducing the number of pixels to an arbitrary size.

Reference numerals 102 and 103 may be connected in reverse to inputs (a, b, c, d, . . . ). That is, it is also possible to perform enlargement and reduction at reference numeral 103 from the inputs a, b, c, and d, and then rearrange and output in the input order at reference numeral 102.

Reference numeral 104 denotes a buffer. The input of reference numeral 103 or 102 can be buffered and output in an arbitrary order.

Reference numeral 105 denotes a pixel synthesizing unit. The pixel data are read out from reference numeral 104 in the output order of the entire output screen, synthesized and output. This synthesis is as described above. Reference numeral 105 may add an arbitrary control signal to a blanking portion of the screen.

The video synthesizing device 10 of the present disclosure can also be realized by a computer and a program, and the program can be recorded in a recording medium or provided through a network.

### Points of Present Disclosure

As described above, the present disclosure is a system for inputting a plurality of asynchronous videos and synthesizing the images, and in output, a screen is synthesized and output at a rate higher than an input frame rate. Here, in output synthesis, input data is output as soon as possible without waiting for the completion of input for one screen, and shortage of input data is supplemented with past frame data. Thus, the present disclosure can shorten the delay time to output after synthesis for an asynchronous video input signal. Therefore, cooperative work in which a low delay request is severe and in particular, a low delay request to a specific input is severer can be performed in a system for synthesizing a plurality of screens from a plurality of bases or the like.

### INDUSTRIAL APPLICABILITY

The present disclosure is applicable to information and communication industries.

### REFERENCE SIGNS LIST

10 Video synthesizing device
20 Screen
21 Scanning line
22 Blanking portion
23 Border portion
24 Display screen
101 Detection unit
102 Crossbar switch
103 Up-down converter
104 Buffer
105 Pixel synthesizing unit

1. A device for synthesizing a plurality of video signals input asynchronously into a video signal displayed on one screen,
wherein, when input of an input frame is not completed for any one of the plurality of video signals,
using data of a past input frame of the video signal instead of data whose input has not been completed,
the video signal displayed on the one screen is synthesized.

2. The device according to claim 1, wherein at least one of the plurality of video signals has a different frame rate.

3. A method for synthesizing a plurality of video signals input asynchronously into a video signal displayed on one screen,
wherein, when input of an input frame is not completed for any one of the plurality of video signals,
using data of a past input frame of the video signal instead of data whose input has not been completed,
the video signal displayed on the one screen is synthesized.

4. A non-transitory computer-readable medium having computer-executable instructions that, upon execution of the instructions by a processor of a computer, cause the computer to function as the device according to claim 1.
